(19) United States
(12) Patent Application Publication
(10) Pub. No.: US 2022/0224774 A1
(43) Pub. Date: Jul. 14, 2022

(54) APPLICATION PROGRAMMING INTERFACE FOR NETWORK SERVICE DEVICES

(71) Applicant: Level 3 Communications, LLC, Broomfield, CO (US)

(72) Inventor: Francis Ferguson, Denver, CO (US)

(73) Assignee: Level 3 Communications, LLC, Broomfield, CO (US)

(21) Appl. No.: 17/570,095

(22) Filed: Jan. 6, 2022

Related U.S. Application Data
(60) Provisional application No. 63/135,341, filed on Jan. 8, 2021.

(51) Int. Cl. H04L 67/133; H04L 67/51; G06F 9/54; H04L 41/5041; H04L 67/00

(52) U.S. Cl. CPC H04L 67/40; H04L 67/16; H04L 67/34; H04L 41/5045; G06F 9/547

(57) ABSTRACT

The present application describes a standardized application programming interface for network service devices. The application programming interface may be provided to network service devices of different manufacturers. Each network service device may, upon an initial boot sequence, perform a self-discovery process and gather information in a standardized format required by the application programming interface. The standardized information may then be made available to a network service provider and to other network service devices on the network.

### CROSS-REFERENCE TO RELATED APPLICATIONS

This application claims the benefit of U.S. Provisional Application No. 63/135,341 filed 8 Jan. 2021, entitled “Application Programming Interface for Network Service Devices,” which is incorporated herein by reference in its entirety.

### BACKGROUND

Various network service devices, such as routers, ethernet switches, etc. on a particular network may be manufactured by a number of different manufacturers. Each of these manufacturers may require that the network service device stores certain kinds of information in a certain format. As such, it is difficult to request and receive standardized data from each network service device in a heterogeneous network. As such, storing, tracking, and normalizing data about network service devices is challenging.

### SUMMARY

The present application describes an application programming interface that may be used across a number of different network service devices. The application programming interface may be used to standardize data across each of the different network service devices even if the network service devices are manufactured by different manufacturers. In an example, the application programming interface causes each network service device on which it is installed to perform a self-discovery process when the network service device performs its initial boot sequence and/or when the network service device is connected to a network. The information obtained in the self-discovery process may include a network topology associated with the network service device, service capabilities of the network service device, and a service inventory associated with the network service device. This information may be stored on the network service device in standardized format.

Accordingly, the present application describes a method comprising receiving, from a first network service device associated with a network, information about the first network service device based on an initial boot sequence of the first network service device. In an example, the information is formatted in a particular format specified by an application programming interface. The application programming interface may be associated with a network service provider and the first network service device may be associated with a first manufacturer. The method also includes receiving, from a second network service device associated with the network, information about the second network service device based on an initial boot sequence of the second network service device. In an example, the information is formatted in the particular format specified by the application programming interface associated with the network service provider. The second network service device may be associated with a second manufacturer. The information from the first network service device is stored in a database associated with the network. Additionally, the information from the second network service device is stored in the database associated with the network.

The present application also describes a system comprising a first network service device, a second network service device and a network database. In an example, the first network service device is associated with a first manufacturer and the second network service device is associated with a second manufacturer that is different from the first manufacturer. The network database is configured to receive first information from the first network service device. In an example, the first information is in a standardized format specified by an application programming interface associated with a network service provider. The network storage device also receives second information from the second network service device. The second information is in the standardized format specified by the application programming interface associated with the network service provider. The first information and the second information is stored in the network storage device.

The present application also describes a method performed by a network service device. The method includes accessing an application programming interface stored on the network service device during an initial boot sequence of the network service device. In an example, the application programming interface is associated with a network service provider. During the initial boot sequence, a self-discovery process specified by the application programming interface is performed. The self-discovery processing includes determining information corresponding to a topology associated with the network service device, service capabilities of the network service device, and a service inventory associated with the network service device. This information may then be stored in a storage device associated with the network service device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates an example system in which multiple network service devices utilize a standardized application programming interface in order to share information with a network service provider according to an example.

FIG. 1B illustrates the example system of FIG. 1A in which a self-discovery process is performed by each of the network service devices and in which resulting information is provided to a network storage device according to an example.

FIG. 1C illustrates the example system of FIG. 1B in which an additional network service device is added to the system according to an example.

FIG. 2 illustrates example systems of a network service device according to an example.

FIG. 3 illustrates a method in which a network service device performs a self-discovery process according to an example.

FIG. 4 is a block diagram of a computing device according to one or more examples.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

A network may be comprised of various network service devices. Some of these network service devices may include, but are not limited to, network access devices, processing devices, storage devices routers, ethernet switches, network interface units and the like. In current networks, it is common for some of the network service devices to be manufactured by different manufacturers. Each manufacturer may track or otherwise store different types of information. Additionally, each manufacturer may store the information in a different format. As such, it can be difficult for a network service provider to determine which network devices store which type of information and how to access the needed information. In some examples, the desired information (e.g., network topology information associated with a network service device) may not be stored at all on the network service device. In such an example, that information may need to be inferred by the network service provider from other available information.

Accordingly, the examples described herein are directed to an application programming interface that specifies a common data model for network service devices that are provided on a particular network. The application programming interface may be associated with a particular network service provider such that any network service device on a network controlled by the network service provider share the common data model. In an example, the application programming interface may define various calls and expected data that is be returned as a result of those calls. In an example, the network service device may include a discovery system that, in accordance with the definitions, calls, etc. associated with the application programming interface, discovers and/or stores: network service device information (e.g., a role of the network service device, a model number of the network service device, software information associated with the network service device, a manufacturing date of the network service device, a date on which the network service device was connected to the network, etc.); port inventory of the network service device; a network topology associated with the network service device; service capabilities of the network service device; and a service inventory that lists the various services that are configured on the device.

In an example, a network topology associated with the network service device may include a description of physical connections and/or logical connections between a particular network service device and adjacent network service devices. Network service device topology can be derived from networks protocols, LLDP, OSPF, ISIS, BGP, RSVP, LDP, IP addressing, VLANs MAC addresses and the like. In an example, service capabilities of the network service device may include a list of services that are supported on the network service device. Example services may include ethernet services such as E-LAN, E-LINE, E-access, IP based services such as IPVPN, internet broadband or business internet, voice services, TDM services, etc. In some examples, different network service devices may support different service features (e.g., routing protocols, multicast, class of service, port types—100M, 1G, 10G, 100G, 400G). In some examples, the service capabilities identify a unique list of the service features that are supported by a particular network service device. In an example, the service inventory provides a list of the services that are provisioned on the network service device. For each service that is provisioned, a list of the features that are configured for the network service device are also provided. Each service may have a born-on date that identifies when the service was added and a service update-date that indicates the last time the service was updated.

In an example, the application programming interface may enable the discovery system to gather the information described above from the network service device. For example, the discovery system, using various application programming interface calls associated with the application programming interface may utilize a “get” request in which information about the network service device is discovered and/or stored. In another example, the discovery system and application programming interface may cause the network service device to add and/or update the information described above. For example, the discovery system may utilize a “post” or “put” request to add or update information associated with the network service device. The updated information may include changes to a network topology associated with the network service device and/or changes to an infrastructure and/or services that are configured on the network service device. In another example, the various requests may be provided to the network service device from a monitoring server on the network.

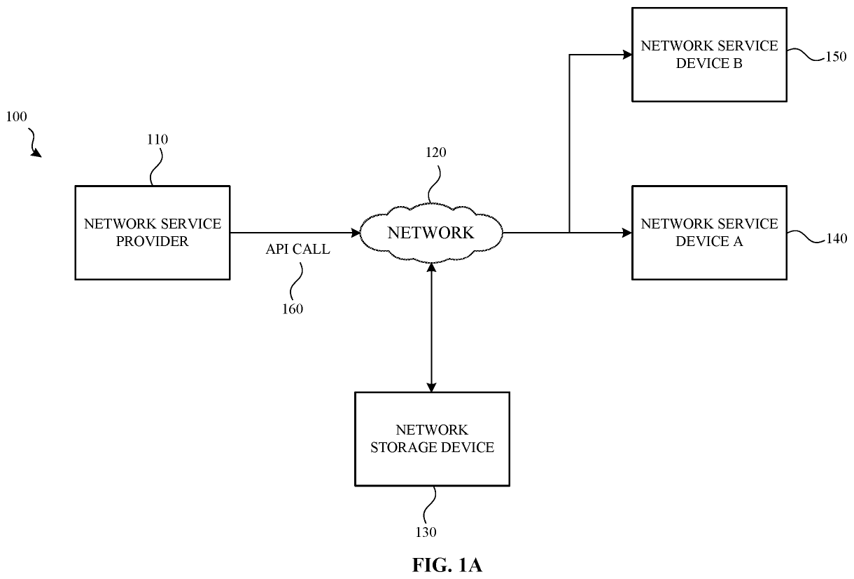

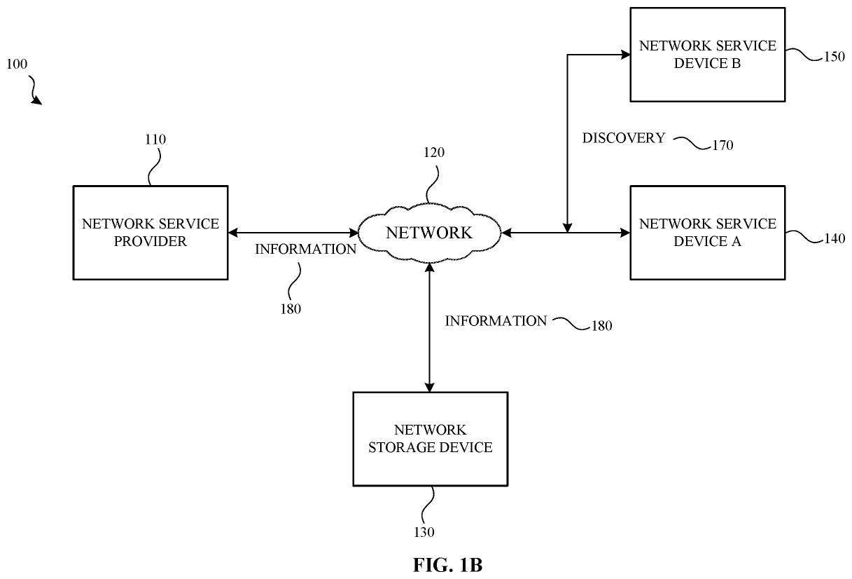

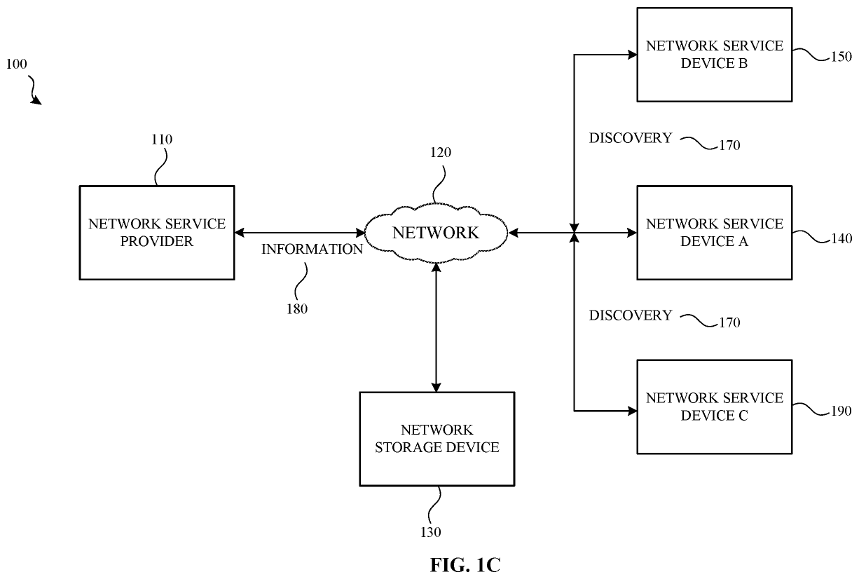

These and other examples will be explained in more detail below with respect to FIG. 1A-FIG. 4. It will be appreciated that the examples shown by the figures and described herein may be used across the various implementations described herein.

FIG. 1A illustrates an example system 100 in which multiple network service devices utilize a standardized application programming interface to share information with a network service provider 110 according to an example. As shown in FIG. 1A, the system 100 may include a network service provider 110 that provides network access to various computing devices (not shown). The system 100 also includes a number of different network service devices such as Network Service Device A 140 and Network Service Device B 150. Although two network service devices are shown, the system 100 may include any number of different network service devices. In an example, Network Service Device A 140 and/or Network Service Device B 150 may be a network access device, a processing device, a storage device, a router, an ethernet switch, a network interface unit, or other such network service device. In an example, Network Service Device A 140 may be manufactured by a first manufacturer and Network Service Device B may be manufactured by a second, different manufacturer.

The network service provider 110 may include or otherwise have access to a network infrastructure that enables various computing device to have access to the internet. In an example, some of the network infrastructure is represented by network 120. Additionally, network 120 may be comprised of additional network service devices such as routers, switches, access points and the like.

The system 100 may also include a network storage device 130. The network storage device 130 may be configured to receive and/or store information associated with each network service device associated with the system 100.

As briefly mentioned above, each network service device associated with the network 120 may be manufactured by different manufacturers. However, in order to ensure that desired information about each network service device is discovered and/or stored, the network service provider 110 may be associated with or otherwise specify a particular application programming interface that must be utilized by each network service device in the system 100. For example, the internet service provider may create an application programming interface that describes a common data model that Network service device A 140 and Network service device B 150 are to use when each network service device is connected to the system 100. Thus, when the network service provider 110 issues an application programming interface call (shown as API call 160) for specific information to Network Service Device A 140 and/or Network Service Device B 150, the network service provider 110 can be assured that the network service device will have the requested information and the requested information will be in a desired format.

For example and referring to FIG. 1B, when Network Service Device A 140 and/or Network Service Device B 150 are manufactured, the manufacturer may store the application programming interface directly on a storage system of the network service device. When the network service device undergoes an initial boot process (e.g., the network service device is connected to the network 120 or is otherwise associated with system 100), a discovery system may utilize the application programming interface to cause the network service device to undergo a self-discovery process. Alternatively, the discovery system and/or the application programming interface may be downloaded to the network service device, e.g., when the network service device is first connected to network 120. In examples, a manufacturer of the network service device may install multiple application programming interfaces and/or discovery systems for multiple potential network providers. The network service device and/or a discovery system may then determine, during an initial boot process, the particular network provider 110 that is associated with the network to which the network service device is connected, and utilize the appropriate one of the multiple application programming interfaces and/or discovery systems for that network. In an example, the discovery system may be used to determine the appropriate one of the multiple application programming interfaces.

The self-discovery process may enable the network service device, via the discovery system, to discover and/or store information about the network service device itself. This information may include, but is not limited to, a role of the network service device, a model number of the network service device, software information associated with the network service device, a manufacturing date of the network service device, a vendor/manufacturer of the network service device, a date/time at which the network service device was connected to the network, port inventory of the network service device, a network topology associated with the network service device, service capabilities of the network service device, and a service inventory of the services. Although specific information is specified, these are for example purposed only.

Some of the information listed above may be stored or otherwise discoverable on the device. In other examples, such as discovering a network topology associated with the network service device, the network service device may need to communicate with other network service devices via the network 120 or other communication channel. For example, when Network Service Device A 140 is connected to the network 120 for the first time, the discovery system, via the application programming interface, may cause a discovery request 170 to be initiated by Network Service Device A 140. The discovery request 170 may provide network topology information to Network Service Device A 140 information indicating that Network Service Device A 140 is connected to network 120 and/or to Network Service Device B 150. The discovery request 170 may also be used to determine a role, a function and/or a status of Network Service Device A 140 with respect to the network service provider 110.

In an example, as this information is discovered or otherwise determined by the network service device, the network service device may store this information in a storage system associated with the network service device. In another example, the information 180 may be provided to a network storage device 130. The information 180 may also be provided to the network service provider 110. As additional network service devices are added to (or removed from) the system 100, respective discovery systems and application programming interfaces may cause each network service device in the system to update the stored information.

For example and referring to FIG. 1C, when a new network service device (e.g., Network service device C 190) is added to the system 100, the discovery process 170 may cause Network Service Device A 140 to update its network topology information. Once updated, the information may be stored by Network Service Device A 140 and/or provided to the network storage device 130 via the network 120.

In an example, each network storage device in the system 100 utilizes the same application programming interface to communicate with each other and/or with the network service provider 110. As such, when any of the network service devices initiate a discovery request 170, each network service device is ensured that all of the other network service devices will have the requested information in a standardized format.

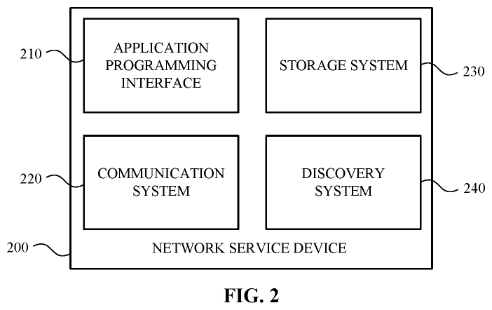

FIG. 2 illustrates example systems of a network service device 200 according to an example. The network service device 200 may be similar to Network Service Device A 140, Network Service Device B 150 and/or Network Service Device C 190 shown and described with respect to FIG. 1A-FIG. 1C.

In the example shown in FIG. 2, the network service device 200 may include an application programming interface 210. In an example, the application programming interface 210 may be stored by the network service device 200. The application programming interface 210 may be associated with a network service provider. For example, the network service provider may use the application programming interface 210 to specify a common data model that will be used by the network service device 200 when the network service device 200 is attached to a network provided by the network service provider.

The network service device 200 may also include a communication system 220 that enables the network service device 200 to communicate with other network service devices on the network and/or with the network service provider. The communication system 220 may also enable the network service device 200 to initiate a discovery request, receive updates and/or API calls from the network service provider and/or receive updates and other requests from other network service devices.

The network service device 200 may also include a storage system 230. The storage system 230 may store the application programming interface 210. The storage system 230 may also store information that is discovered by the network service device 200 when the network service device initiates a self-discovery process (using discovery system 240) and/or undergoes its initial boot process.

For example, when the network service device 200 undergoes an initial boot process or otherwise initiates a self-discovery process, a discovery system 240 of the network service device 200, in conjunction with the application programming interface 210, may cause the network service device to discover and store a variety of information.

In examples, this information may include a function, role, or status of the network service device 200 with respect to a particular network service provider, network topology information associated with the network service device, a model number of the network service device 200, software information associated with the network service device, a date/time at which the network service device was connected to the network, port information associated with the network service device, service capabilities of the network service device 200, bandwidth support metrics, network topology information, physical location associated with the network service device (e.g., location of a server on which the network service device is located) and so on. Although specific information is listed other information may be discovered and/or stored on the network service device 200.

In examples, the information may be retrieved and/or stored on the network service device 200 using a variety of get, post and/or put requests. Examples of such requests, and an example application programming interface, are included in the Appendix included herewith.

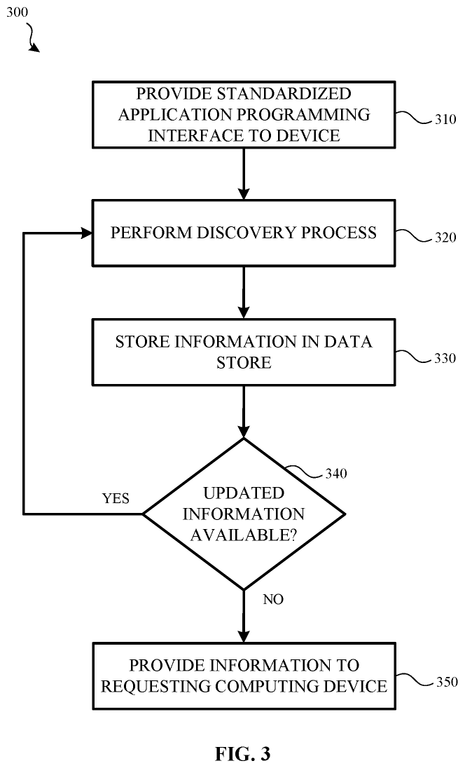

FIG. 3 illustrates a method 300 for receiving standardized information from various network service devices as a result of a standardized application programing interface according to an example. The method 300 may be performed by a network service device such as, for example, Network service device A 140, Network service device B 150 and/or Network service device C 190 shown and described with respect to FIG. 1A-FIG. 1C. Method 300 may also be performed by the network service device 200 shown and described with respect to FIG. 2.

Method 300 begins when a standardized application programming interface is provided (310) to a network service device. In an example, the application programming interface is associated with a network service provider. For example, the network service provider may specify, via the application programming interface, the information that should be discovered by and/or stored on the network service device when the network service device is attached or otherwise associated with a network provided by the network service provider. The application programming interface may be stored on the network service device.

When the network service device has been associated with the network, the network service device may perform (320) a self-discovery process. The self-discovery process may cause the network service device to discover and/or store various types of information. In an example, this information may include, but is not limited to, a role of the network service device, a vendor of the network service device, model information of the network service device, software information of the network service device, location information of the network service device, lifecycle status of the network service device, a born-on date of when the network service device is/was discovered on the network. The discovery process may also enable the network service device to determine or otherwise identify ports of the network service device, service capabilities of the network service device, service inventory of the network service device and a network topology (e.g., neighboring network service devices) associated with the network service device.

In an example, a module or other software component (e.g., a discovery system) associated with the application programming interface may query various systems, subsystems and components of the network service device in order to determine this information. For example, when a network service provider wants information about the network service device, the network service device may, via an API call provide a “get” request to the network service device. In response to the get request, the discovery module may utilize the application programming interface to obtain or otherwise determine the desired information.

A get request may be used to retrieve summary information from the network service device. For example, a get request may retrieve the device role, vendor, model, software, location, lifecycle status and the born-on date of when this device was discovered on the network. Another get request may retrieve hardware information from the network service device. The hardware information may include a summary of the network service device, chassis information of the network service device, cards and power supplies of the network service device and so on. In yet another example, the get request may retrieve port inventory of the network service device. The port inventory may include information about the physical and logical ports of the network service device. A get request may also retrieve network service device topology that includes information about the infrastructure associated with the network service device. For example, this information may include information regarding connected switches, routers, etc.

In another example, the network service device may receive, via an API call provided by the network service provider, one or more “put” or “post” requests. These requests may be requests to store received or updated information on the network service device. For example, a post request may be used to add a network service device to a network and/or a network database. When one of these requests is received, the discovery module may store the updated information in a format and/or location specified by the application programming interface.

Once the discovery process is complete, the determined/discovered information may be stored (330) on the network service device. In some examples, the information may additionally or alternatively be stored on a network storage device.

In some examples, some of the information that is discovered in the discovery process may need to be updated. For example, a new network service device may be added to the network topology associated with the network service device. In another example, a software version of software associated with the network service device may be updated. In yet another example, a network service device may be removed from the network topology associated with the network service device. When any of these events occur, the network service device may determine (340) whether information stored on the network service device needs to be updated.

In an example, an application programming interface call provided by the network service provider may cause changed data to be updated. In another example, the network service device may periodically analyze its data and automatically update stored data as needed. As such, if it is determined that updated information is available, the network service device may perform (320) subsequent discovery processes in order to identify updated information. The updated information is then stored (330).

Once the information has been stored, the information may be provided (350) to a requesting computing device. In an example, the information may be provided to the requesting computing device in a format that is specified by the application programming interface.

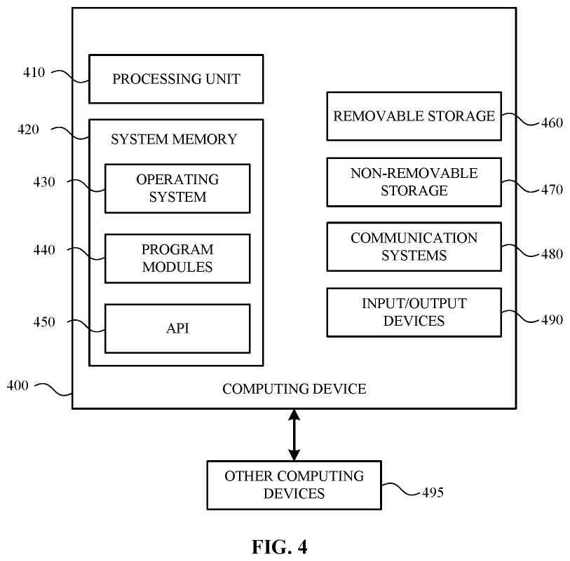

FIG. 4 is a system diagram of a computing device 400 according to an example. The computing device 400, or various components and systems of the computing device 400, may be integrated or associated with a network service device and/or the network service provider. As shown in FIG. 4, the physical components (e.g., hardware) of the computing device are illustrated and these physical components may be used to practice the various aspects of the present disclosure.

The computing device 400 may include at least one processing unit 410 and a system memory 420. The system memory 420 may include, but is not limited to, volatile storage (e.g., random access memory), non-volatile storage (e.g., read-only memory), flash memory, or any combination of such memories. The system memory 420 may also include an operating system 430 that controls the operation of the computing device 400 and one or more program modules 440. The program modules 440 may be responsible for gathering or determining information specified by the API 450. A number of different program modules and data files may be stored in the system memory 420. While executing on the processing unit 410, the program modules 440 may perform the various processes described above.

The computing device 400 may also have additional features or functionality. For example, the computing device 400 may include additional data storage devices (e.g., removable and/or non-removable storage devices) such as, for example, magnetic disks, optical disks, or tape. These additional storage devices are labeled as a removable storage 460 and a non-removable storage 470.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 4 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 400 on the single integrated circuit (chip). The disclosure may also be practiced using other technologies capable of performing logical operations such as, for example, AND, OR, and NOT, including but not limited to mechanical, optical, fluidic, and quantum technologies.

The computing device 400 may include one or more communication systems 480 that enable the computing device 400 to communicate with other computing devices 495 such as, for example, routing engines, gateways, switches, routers, other network service devices and the like. Examples of communication systems 480 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 400 may also have one or more input devices and/or one or more output devices shown as input/output devices 490. These input/output devices 490 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 420, the removable storage 460, and the non-removable storage 470 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method, comprising:
providing an application programming interface;
receiving, from a first network service device associated with a network, information about the first network service device based on an initial boot sequence of the first network service device, the information being formatted in a particular format specified by the application programming interface, the first network service device being associated with a first manufacturer;
receiving, from a second network service device associated with the network, information about the second network service device based on an initial boot sequence of the second network service device, the information being formatted in the particular format specified by the application programming interface, the second network service device being associated with a second manufacturer;
storing the information from the first network service device in a database associated with the network; and
storing the information from the second network service device in the database associated with the network.

2. The method of claim 1, wherein the application programming interface is associated with a network service provider.

3. The method of claim 1, wherein the initial boot sequence of the first network service device causes the first network service device to discover at least a portion of the information about the first network service device.

4. The method of claim 1, wherein the initial boot sequence of the second network service device causes the second network service device to discover at least a portion of the information about the second network service device.

5. The method of claim 1, wherein providing the application programming interface comprises providing the application programming interface to the first network service device upon detecting that the first network service device has been connected to the network.

6. The method of claim 1, further comprising causing the first network service device to provide the information about the first network service device to the second network service device.

7. The method of claim 1, wherein the information about the first network service device comprises at least one of information about ports of the first network service device, service capabilities of the first network service device, a service inventory of the first network service device, or a network topology associated with the first network service device.

8. A system, comprising:
a first network service device, the first network service device being associated with a first manufacturer and including an application programming interface;
a second network service device, the second network service device being associated with a second manufacturer that is different from the first manufacturer and including the application programming interface; and
a network database, connected to a network and configured to:
receive first information from the first network service device, the first information being in a standardized format specified by the application programming interface associated with a network service provider;
receive second information from the second network service device, the second information being in the standardized format specified by the application programming interface associated with the network service provider; and
storing the first information and the second information.

9. The system of claim 8, wherein the application programming interface is associated with a network service provider.

10. The system of claim 8, wherein an initial boot sequence of the first network service device causes the first network service device to discover at least a portion of the information about the first network service device.

11. The system of claim 8, wherein an initial boot sequence of the second network service device causes the second network service device to discover at least a portion of the information about the second network service device.

12. The system of claim 8, further comprising a network service provider system, wherein the network service provider system is configured to provide the application programming interface to the first network service device upon detecting that the first network service device has been connected to the network.

13. The system of claim 8, wherein the first network service device is configured to provide the information about the first network service device to the second network service device upon an initial boot sequence of the first network service device.

14. The system of claim 8, wherein the information about the first network service device comprises at least one of information about ports of the first network service device, service capabilities of the first network service device, a service inventory of the first network service device, or a network topology associated with the first network service device

15. A method performed by a network service device, comprising:
receiving an application programming interface associated with a network service provider;
upon an initial boot sequence, accessing the application programming interface stored on the network service device;
performing a self-discovery process specified by the application programming interface, the self-discovery processing including determining information corresponding to:
a topology associated with the network service device on a network of the network service provider;
service capabilities of the network service device; and
a service inventory associated with the network service device; and
standardizing the information according to the application programming interface; and
storing the standardized information in a storage device.

16. The method of claim 15, wherein the initial boot sequence of the first network service device causes the first network service device to perform the self-discovery process.

17. The method of claim 15, further comprising providing the standardized information in response to an application programming interface call from the network service provider.

18. The method of claim 15, wherein receiving the application programming interface comprises receiving the application programming interface in response to the first network service device being connected to the network for a first time.

19. The method of claim 15, further comprising providing at least a portion of the information to a second network service device connected to the network.

20. The method of claim 19, wherein providing at least a portion of the information to a second network service device connected to the network comprises a portion of the initial boot sequence.
